(19) United States
(12) Patent Application Publication
(10) Pub. No.: US 2026/0370773 A1
(43) Pub. Date: Nov. 19, 2026

(54) IMAGE PROCESSING APPARATUS, METHOD OF CONTROLLING IMAGE PROCESSING APPARATUS, AND STORAGE MEDIUM

(71) Applicant: CANON KABUSHIKI KAISHA, Tokyo (JP)

(72) Inventors: TAKERU SASAKI, Kanagawa (JP); YUGO MOCHIZUKI, Kanagawa (JP); MASAO KATO, Kanagawa (JP)

(21) Appl. No.: 19/673,081

(22) Filed: May 11, 2026

(30) Foreign Application Priority Data
May 14, 2025 (JP) 2025-081171

(51) Int. Cl. H04N 1/60; G01J 3/50; H04N 1/00

(52) U.S. Cl. CPC H04N 1/6077; G01J 3/50; H04N 1/0044; H04N 1/00482; H04N 1/6086; H04N 2201/0094

(57) ABSTRACT

An object of the present disclosure is to improve the accuracy of color reproduction of a back light film in an environment in which a front light is present. An embodiment of the present disclosure is an image processing apparatus including: an obtaining unit configured to obtain a viewing light source condition on viewing light sources expected to be present in a viewing environment, the viewing light source condition including a condition on a first light source expected to be a transmissive light source and a condition on a second light source different from the first light source; and a color conversion unit configured to perform a color conversion process based on the viewing light source condition on input image data.

### CROSS-REFERENCE TO PRIORITY APPLICATION

This application claims the benefit of Japanese Patent Application No. 2025-081171, filed May 14, 2025, which is hereby incorporated by reference herein in its entirety.

### FIELD OF THE TECHNOLOGY

The present disclosure relates to an image processing apparatus, a method of controlling an image processing apparatus, and a storage medium.

### DESCRIPTION OF THE RELATED ART

Recording apparatuses that record an image on a recording medium by applying recording agents, such as inks, have been known. There are recording media suitable as display materials to be used in these recording apparatuses, such as illumination signs using a back light, and back light films have been known as such recording media.

There has heretofore been a problem that the accuracy of the color reproduction of a back light film is deteriorated due to a difference in the color temperature of the back light. Japanese Patent Laid-Open No. 2006-173883 discloses a technique in which optimal image processing parameters are applied according to the color temperature of a back light as a technique for addressing this problem.

### SUMMARY

In a case of viewing an output product obtained by performing recording on a back light film in an environment in which a front light, such as an indoor fluorescent lamp, is present, the human eye perceives transmitted light from the back light and reflected light from the front light. A problem with Japanese Patent Laid-Open No. 2006-173883 is that image processing is performed based only on the color temperature of the back light and the effect of the color temperature of the front light is not taken into account, hence deteriorating the accuracy of color reproduction.

In view of the above problem, the present disclosure is capable of improving the accuracy of color reproduction of a back light film in an environment in which a front light is present.

An embodiment of the present disclosure is an image processing apparatus including: an obtaining unit configured to obtain a viewing light source condition on viewing light sources expected to be present in a viewing environment, the viewing light source condition including a condition on a first light source expected to be a transmissive light source and a condition on a second light source different from the first light source; and a color conversion unit configured to perform a color conversion process based on the viewing light source condition on input image data.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of a printing system according to a first embodiment.

FIG. 2 is a diagram for describing scanning of a recording head and an operation of conveying a recording medium according to the first embodiment.

FIG. 3 is a diagram for describing scans of the recording head and its corresponding nozzle positions according to the first embodiment.

FIG. 4 is a diagram illustrating an arrangement of nozzle arrays of the recording head according to the first embodiment as viewed from the upper surface of a recording apparatus.

FIG. 5 is a flowchart of a recording process according to the first embodiment.

FIG. 6 illustrates a graphical user interface (GUI) screen according to the first embodiment.

FIG. 7 is a table to be referenced in a case of determining a color matching table to be used.

FIGS. 8A and 8B are diagrams for describing a method of creating a color matching table.

FIG. 9 is a diagram for describing conditions for creating color matching tables.

FIG. 10 is a diagram for describing an effect of the color temperature of a front light on the color reproducibility of a back light film.

FIG. 11 is a table to be referenced in a case of determining a color matching table to be used.

FIGS. 12A and 12B illustrate GUI screens according to a second embodiment.

FIG. 13 is a diagram showing the relationship among FIG. 13A, FIG. 13B, and FIG. 13C;

FIG. 13A, FIG. 13B, and FIG. 13C are flowcharts illustrating the processing of setting up a connection to an access point;

FIGS. 14A and 14B are diagrams for describing another embodiment.

### DESCRIPTION OF THE EMBODIMENTS

Preferred embodiments according to the present disclosure will be specifically described below with reference to the accompanying drawings. Note that the following embodiments are not intended to unnecessarily limit the present disclosure, and not all of the combinations of the features described below are necessarily essential for the solution to be provided by the present disclosure. Moreover, the positions, shapes, and the like of the constituent elements described in the following embodiments are mere examples, and the technical scope of the present disclosure is not limited only to those.

### Definitions of Terms

First of all, terms used herein will be defined as below in advance.

### “Recording”

The term “recording” is not limited to a representation of only the act of forming information with a meaning, such as a character or a figure. It is irrelevant whether the information has a meaning or not, and it is also irrelevant whether the information is elicited so as to be visually perceptible to humans. The term is broadly interpreted to represent formation of an image, a design, a pattern, or the like on a recording medium and also processing of a medium.

### “Recording Medium”

The term “recording medium” represents not only paper used in general recording apparatuses but also things that can receive inks including cloth, plastic films, sheet metal, glass, ceramic, resin, wood, and leather. Note that a recording medium may be referred to simply as “medium” herein.

### “Ink”

The term “ink” should be broadly interpreted like the definition of the term “recording” described above, and represents a medium that is applied onto a recording medium to form an image, a design, a pattern, or the like or process the recording medium or represents a medium containing a recording agent to be used in processing of an ink (e.g., a reaction liquid). Regarding the physical state, it is liquid. The “processing of an ink” mentioned above means solidification or insolubilization of a color material in an ink applied onto a recording medium, for example.

### “Nozzle”

The term “nozzle” represents an ejection orifice unless otherwise noted. A nozzle incorporates liquid paths communicating with each other and an element that generates an energy to be used to eject an ink.

### “Scanning”

To perform recording on a recording medium, a recording head is scanned over the recording medium and performs recording thereon. In the present disclosure, moving of a head for recording or for an operation related to recording is defined as “scanning.”

### “Reciprocal Recording”

The term “reciprocal recording” represents performing the above-described “recording” with reciprocal movement over the recording medium. Note that the terms “reciprocal scanning,” bi-directional scanning,” and “bi-directional recording” refer to similar actions.

### “Color Reproduction Range”

The term “color reproduction range” is also expressed as “color gamut” or “gamut.” Generally, the term indicates the range of reproducible colors within any color space.

Color gamut volume is an index representing the size of a color reproduction range. The color gamut volume refers to a three-dimensional volume in any color space. The color reproduction range may be formed by discrete chromaticity points. For example, a specific color reproduction range may be represented by 729 points in CIE-L*a*b*, and points therebetween may be determined using a publicly known interpolation operation, such as tetrahedral interpolation or cubic interpolation. In such a case, a value obtained by accumulating the volumes, in CIE-L*a*b*, of tetrahedrons, cubes, or the like that form the color reproduction range in accordance with the interpolation operation method can be used as the corresponding color gamut volume.

While the color reproduction range in the present disclosure is not limited to a specific color space, in the following description, it is described to be a color reproduction range in the CIE-L*a*b* space as an example. Similarly, the numerical value of the color reproduction range in the following indicate a volume calculated by accumulation in the CIE-L*a*b* space based on tetrahedral interpolation.

### “Front Light”

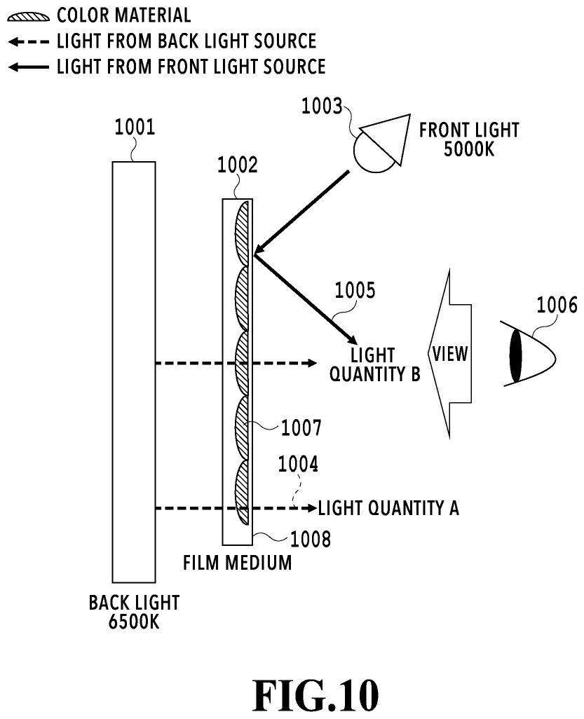

In the present disclosure, a light source that emits light from a front side relative to a viewed surface, such as a fluorescent lamp for indoor lighting or outdoor sunlight, will be referred to as “front light” or “front light source.” This will now be further described with reference to FIG. 10. In FIG. 10, a front light source 1003 irradiates a back light film 1002 from the front side. The light emitted from the front light source 1003 is absorbed and scattered by the back light film 1002 and a color material 1007, and reflected light 1005 reaches a viewer 1006. As described above, a “front light” means a light source that emits light toward a viewed surface 1008 of a recorded medium on its front side. A front light may be referred to as an “environment light” below. Details will be described later. In this specification, a back light film may be referred to also as “recording medium for a transmissive light source.”

### “Back Light”

In the present embodiment, a light source that emits light from a back side (opposite side) relative to a viewed surface, such as an illumination panel or a light emitting diode (LED) transilluminator, will be referred to as “back light” or “back light source.” In FIG. 10, a back light source 1001 irradiates the back light film 1002 from the back side relative to the viewed surface. The light emitted from the back light source 1001 to the back surface of the back light film 1002 is partly absorbed and blocked by the back light film 1002 and the color material 1007, and transmitted light 1004 reaches the viewer 1006. Viewing with a back light means viewing of the transmitted light 1004 by the viewer 1006. As described above, a “back light” means a light source that irradiates a recorded medium from the back side relative to its viewed surface.

### First Embodiment

### <Configuration of Inkjet Recording Apparatus>

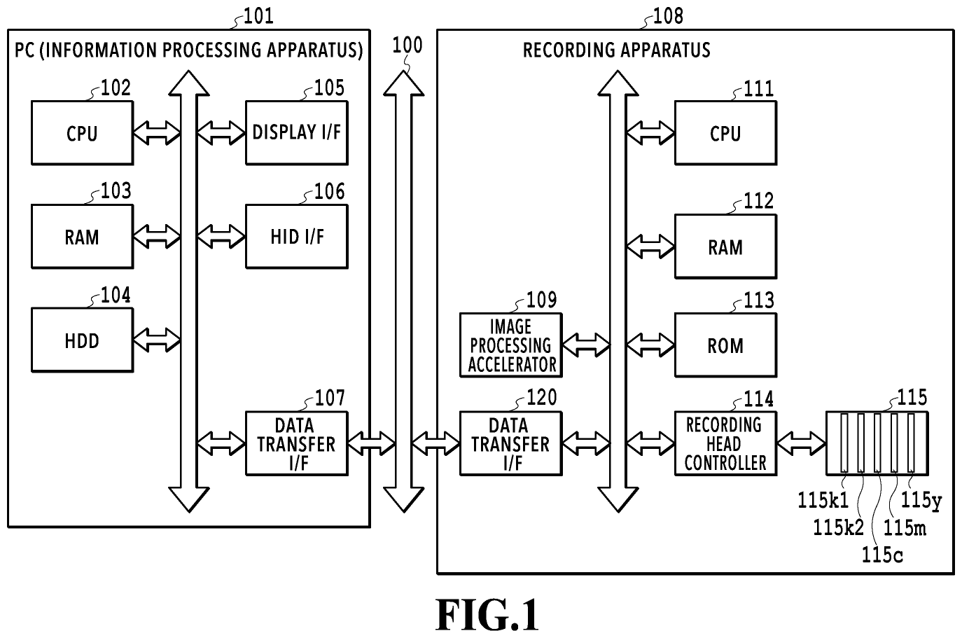

FIG. 1 is a block diagram illustrating a configuration of a printing system according to a first embodiment of the present disclosure.

A personal computer (PC) 101 is an information processing apparatus that processes information and is, for example, a host PC, a smartphone, a tablet PC, or the like. A central processing unit (CPU) 102 of the PC 101 executes various processes by loading programs stored in a hard disc drive (HDD) 104 into a random-access memory (RAM) 103 serving as a work area, and executing the programs. For example, the CPU 102 receives a command corresponding to a user input through a human interface device (HID) I/F 106 including a keyboard, a mouse, and the like or a display unit (not illustrated). Then, in accordance with the received command and a program stored in the HDD 104, the CPU 102 creates image data recordable by a recording apparatus 108, and transmits the created image data to the recording apparatus 108 through a data transfer I/F 107 and a communication line 100. The CPU 102 executes a predetermined process on data received from the recording apparatus 108 through the data transfer I/F 107 and the communication line 100 in accordance with a program stored in the HDD 104, and displays its result and various pieces of information on the display unit via a display I/F 105. Incidentally, the “display unit” mentioned above is, for example, a display panel, a monitor, or the like. This display unit may also serve as an operation unit to be operated by the user.

A CPU 111 of the recording apparatus 108 comprehensively controls the recording apparatus 108 by loading programs stored in a ROM 113 into a RAM 112 serving as a work area, and executing the programs. An image processing accelerator 109 is hardware capable of executing image processing at a higher speed than the CPU 111 does. The image processing accelerator 109 is activated in response to the CPU 111 writing parameters and data necessary for image processing to predetermined addresses in the RAM 112. The image processing accelerator 109 reads these parameter and data and then executes image processing on the read data. Note that the image processing accelerator 109 is not an essential element, and the CPU 111 may be caused to execute equivalent processing. Also, the parameters mentioned above may be stored in the ROM 113 or stored in a storage such as a flash memory or an HDD (not illustrated). A data transfer I/F 120 communicates with the PC 101 through the communication line 100. A recording head controller 114 controls a recording head 115.

The recording apparatus 108 according to the present embodiment uses black-1 (K1, also referred to as “first black”), black-2 (K2, also referred to as “second black”), cyan (C), magenta (M), yellow (Y) inks, for example. The black-1 (K1) ink is an ink with lower permeability whereas the black-2 (K2) ink is an ink with higher permeability.

The permeability of an ink into a recording medium is determined by the surface tension (mN/m) of the ink. The lower the surface tension, the higher the permeability of the ink, and higher the surface tension, the lower the permeability of the ink. In the present embodiment, a surfactant is used to adjust the surface tension; the surface tension of the ink with higher permeability is adjusted to 30 (mN/m) or more and 40 (mN/m) or less, and the surface tension of the ink with lower permeability is adjusted to 40 (mN/m) or more and 60 (mN/m) or less.

The permeability of an ink into a recording medium is also associated with aggregation of the color material in the ink resulting from interactions between the color material and dispersant in the ink and the metal salt or the like contained in the recording medium. In a case where the ink reacts strongly and aggregates quickly, the ink aggregates in the vicinity of the surface of the recording medium, so that the permeability is low. Conversely, in a case where the ink reacts weakly and aggregates slowly, the ink permeates the recording medium without aggregating, so that the permeability is high.

### <Overview of Image Processing>

Image processing performed by the CPU 111 or the image processing accelerator 109 in the recording apparatus 108 will be described below. This image processing is a process of creating recording data indicating positions at which the recording head 115 forms ink dots in each scan based on image data transmitted from the PC 101 and received by the recording apparatus 108. Specifically, the image processing is a series of recording data creation processes including a color conversion process, a quantization process, and the like to be performed on the received image data.

The color conversion process involves a color matching process which is characteristic feature of the present embodiment, as well as a color separation process and a tone correction process. Next, details of the color matching process will be described.

The color matching process is a color conversion process for associating a color space expressible by the PC 101, which is a host apparatus, with a color space expressible by the recording apparatus 108. Generally, for an inkjet printer or the like to output an image, a color conversion process in which image data of an input color signal from an image input apparatus is converted into image data of an output color signal to be used by the printer, or an image output apparatus, is performed to generate output data. The input color signal is specified as colors in a device color space dependent on the image input apparatus (e.g., an RGB color space). On the other hand, the output signal is specified as colors in a device color space dependent on the image output apparatus (e.g., CMYK or RGB). Thus, in the color conversion process, a process of converting the device color space of the input color signal into the color space of the output color signal is performed. As for the conversion method, matrix calculation methods and three-dimensional lookup tables are known. Note that a lookup table will be described as “LUT” herein.

As input color spaces commonly used to specify image data, many color spaces have been known, such as sRGB, Adobe RGB, and NTSC for RGB, for example. In order to be able to perform color conversion from the device color space of an input apparatus into the device color space of an output apparatus for each of multiple input color spaces as listed above, it is necessary to prepare an LUT for each combination of input and output apparatuses that specifies color conversion therebetween.

To address this, a color conversion method using an International Color Consortium (ICC) profile, which enables color conversion regardless of the combination of input and output apparatuses, has been known. The ICC profile specifies color conversion for an input apparatus from its input color space into a device-independent color space and similarly specifies color conversion for an output apparatus from the device-independent color space into the device color space of the output device. Examples of the device-independent space include XYZ, L*a*b*, and the like. Specifically, the color conversion specified by the profile is implemented by using a LUT, as in the above. “Perceptual,” “saturation,” “colorimetric matching,” and the like have been known as color matching methods.

The color separation process is a process of performing color separation of the output-device signal values after the color matching process into ink densities. The color conversion method is implemented by a matric calculation process, a process using a three-dimensional LUT or a four-dimensional LUT, or the like.

The recording apparatus 108 according to the present embodiment uses five types of inks, namely, black-1 (K1), black-2 (K2), cyan (C), magenta (M), and yellow (Y) inks. Thus, image data of an RGB signal is converted into image data formed of 8-bit K1, K2, C, M, and Y color signals. The color signal of each color corresponds to the amount of the corresponding ink to be applied. Also, an example in which the number of ink colors is five, namely, K1, K2, C, M, and Y, has been presented, but inks of other colors, such as a light cyan (Lc) ink, a light magenta (Lm) ink, and a gray (Gy) ink with lower density, may be used in order to improve image quality. In this case, ink signals for those inks are generated.

The color separation process is followed by the tone correction process to correct the dot gain of each ink. The ink data after the tone correction process is subjected to the quantization process. The quantization process is a process of reducing the number of tonal levels in the ink data. In the present embodiment, the quantization process is performed using a dither matrix in which threshold values to be compared with the value of each pixel in the ink data are arranged. After the quantization process, binary data is indicating whether to form a dot is finally created for each dot formation position.

### <Multipass Printing>

After the image processing is thus performed, the recording head controller 114 transfers the binary data to the recording head 115. At the same time, the CPU 111 performs recording control to actuate a carriage motor that actuates the recording head 115 via the recording head controller 114 and also actuates a conveyance motor that conveys the recording medium (sheet). The recording head 115 is scanned over the recording medium and at the same time ejects ink droplets onto the recording medium to thereby record an image.

In a case of performing multi-scan recording, a process of determining the order of scans is performed after the predetermined image processing is performed. The process of determining the order of scans is a process of thinning the image by applying a mask pattern or the like to the data after the quantization process for the purpose of creating a piece of data for each scan. At that time, the image processing accelerator 109 may be used to accelerate the processing.

The PC 101 and the recording apparatus 108 are connected by the communication line 100. The present embodiment will be described using a local area network as an example of the communication line 100, but the communication line 100 may be a connection using a universal serial bus (USB) hub, a wireless communication network using a wireless access point, or a Wi-Fi direction communication function, or the like.

### <Configuration of Recording Head>

In the following, a description will be given on the assumption that the recording head 115 includes a total of five recording nozzle arrays that eject color inks of five colors of cyan (C), magenta (M), yellow (Y), black-1 (K1), and black-2 (K2).

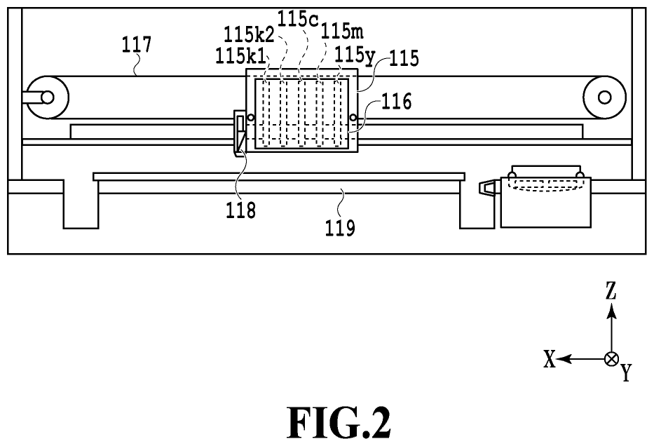

FIG. 2 is a diagram for describing scanning of the recording head 115 and an operation of conveying a recording medium according to the present embodiment.

In the present embodiment, an image is recorded on a unit area for one nozzle array by performing a scan multiple (N) times (N is a natural number of 2 or more (N>1)). The recording head 115 has a carriage 116, nozzle arrays 115k1, 115k2, 115c, 115m, and 115y, and an optical sensor 118. The carriage 116, carrying the five nozzle arrays 115k1, 115k2, 115c, 115m, and 115y and the optical sensor 118, is capable of reciprocally moving along the X direction in FIG. 2 (main scanning direction) with a driving force from a carriage motor transmitted through a belt 117. While the carriage 116 moves in the X direction relative to the recording medium, ink droplets are ejected from nozzles of the nozzle arrays in the direction of gravity (−Z direction in FIG. 2) based on recording data. As a result, an image corresponding to a 1/N main scan is recorded on the recording medium placed on a platen 119. After the completion of one main scan, the recording medium is conveyed along a conveyance direction (−Y direction in FIG. 2) perpendicularly intersecting the main scanning direction by a distance corresponding to the width of a 1/N main scan. As a result of these operations, an image corresponding to the width of one nozzle array is recorded by multiple (N) scans. By alternately repeating a main scan and a conveyance operation as above, images are recorded on the recording medium in a step-by-step manner.

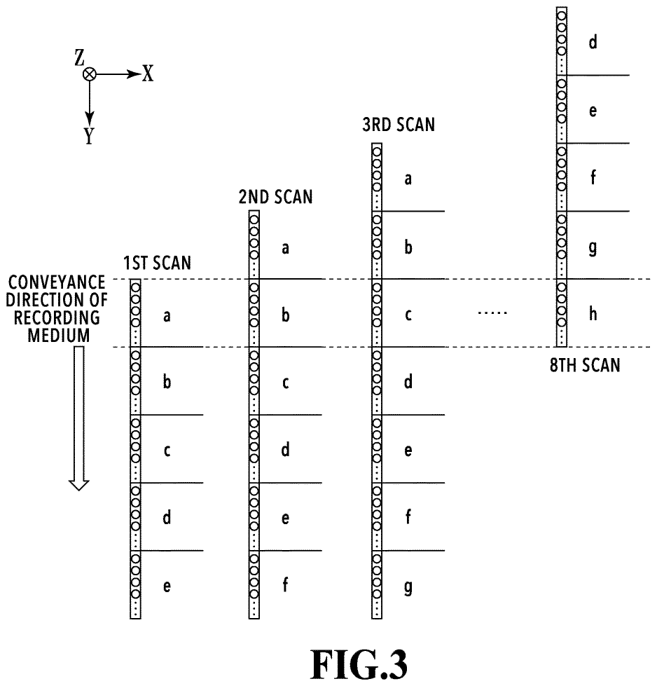

FIG. 3 is a diagram for describing scans of the recording head 115 and its corresponding nozzle positions, and illustrates an example in which N=8 using arbitrary one of the five nozzle arrays included in the recording head 115. Each white circle in FIG. 3 represents an ejection nozzle for ejecting the ink.

An image is recorded on an area corresponding to one nozzle array by sequentially scanning areas a to g starting from the most upstream one in the conveyance direction of the recording medium (Y direction) and lastly an area h. The recording resolution in the X direction is determined based on the ejection frequency and the moving speed of the carriage. The recording resolution in the Y direction is determined based on the recording head 115, in particular based on the nozzle resolution of its nozzle arrays. In the present embodiment, the recording resolution of each nozzle array is set to 600 dpi. Thus, ejected ink dots are recorded at a resolution of 600 dpi in the vertical and horizontal directions. The optical sensor 118 performs a detection operation while moving along with the carriage 116 to determine whether a recording medium is present on the platen 119.

In the present embodiment, the amount of the ink applied by recording four ink dots at this resolution of 600 dpi in the vertical and horizontal directions is defined as 100%.

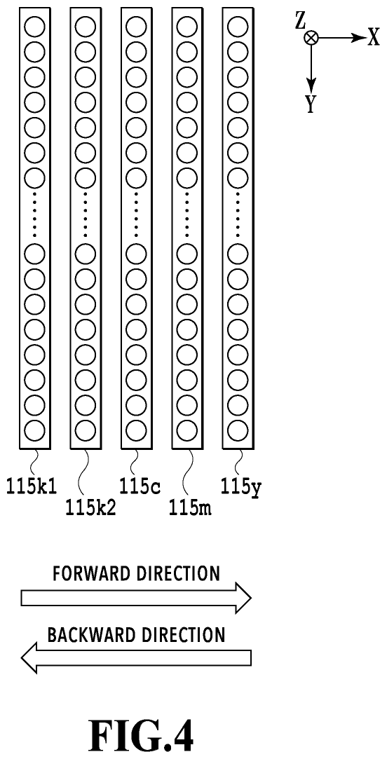

FIG. 4 is a diagram illustrating an arrangement of the nozzle arrays of the recording head 115 as viewed from the upper surface of the recording apparatus 108 in the −Z direction.

In the recording head 115, the five nozzle arrays are disposed at different positions in the X direction. Specifically, the nozzle array 115c for the C ink, the nozzle array 115m for the M ink, and the nozzle array 115y for the Y ink are disposed. Moreover, the nozzle array 115k1 for the K1 ink and the nozzle array 115k2 for the K2 ink are disposed. Ink droplets of the C ink are ejected from the nozzles of the nozzle array 115c, ink droplets of the M ink are ejected from the nozzles of the nozzle array 115m, and ink droplets of the Y ink are ejected from the nozzles of the nozzle array 115y. Moreover, ink droplets of the K1 ink are ejected from the nozzles of the nozzle array 115k1, and ink droplets of the K2 ink are ejected from the nozzles of the nozzle array 115k2. In each nozzle array, multiple nozzles for ejecting ink droplets are arrayed at a predetermined pitch along the Y direction. This predetermined pitch will be referred to as “nozzle resolution.”

### <Recording Medium>

The present embodiment will be described using an example in which a back light film to be recorded by an inkjet recording method is used as the recording medium will be described. Note that the recording medium that can be used in the present embodiment is not limited to a back light film as above. The recording medium only needs to be one that has a substrate and at least one ink receiving layer.

### <Recording Process>

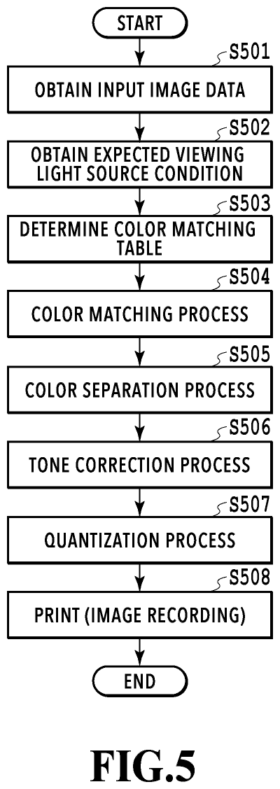

FIG. 5 is a flowchart for describing a recording process by the recording apparatus 108 according to the present embodiment. The CPU 111 implements the recording process illustrated in FIG. 5 by loading a program stored in the ROM 113 to the RAM 112 and executing it. Incidentally, the recording process may be executed partly or entirely by the image processing accelerator 109.

In step S501, the CPU 111 obtains input image data transmitted by the PC 101. In the present embodiment, the CPU 111 functions as an input image data obtaining unit, and the input image data obtained by the CPU 111 is multi-valued data with three channels for red (R), green (G), and blue (B). In the following, “step S_” will be abbreviated as “S_.”

In S502, the CPU 111 obtains an expected viewing light source condition transmitted by the PC 101. The expected viewing light source condition is information on a condition for expected viewing light sources, and is set by the user using the PC 101.

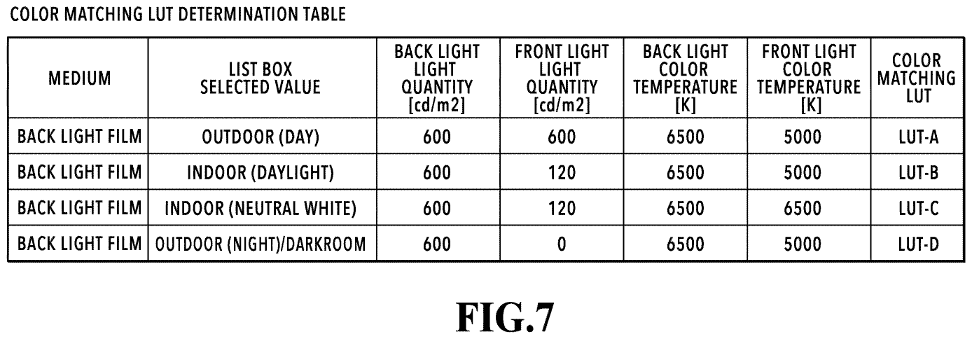

In S503, using a reference table to be described later (FIG. 7), the CPU 111 selectively determines a color matching table corresponding to the expected viewing light source condition obtained in S502. This color matching table is a three-dimensional lookup table (3D-LUT), and multiple color matching tables to be selected are held in the ROM 113 in advance.

In S504, using the color matching table determined in S503, the CPU 111 performs a color matching process on the RGB multi-valued data obtained in S501. The color matching process is a process for associating a color space expressible by the PC 101, which is a host apparatus, with a color space expressible by the recording apparatus 108. The 3D-LUT determined in S503 from among the multiple 3D-LUTs prepared in advance is referenced, and the multi-valued RGB data is converted into multi-valued RGB values. Each of the RGB values after this conversion will be represented as (R′, G′, B′).

In S505, the CPU 111 executes a color separation process of converting the multi-valued data (R′, G′, B′) into multi-valued data corresponding to the ink colors to be used in the recording apparatus. The multi-valued data after this color separation process will be represented as (C, M, Y, K1, K2). In this step too, a 3D-LUT prepared in advance is referenced.

In S506, the CPU 111 performs a tone correction process on each value of the multi-valued data (C, M, Y, K1, K2). The tone correction process is a process for ensuring linearity between the input signal values and the density to be expressed on the recording medium. Specifically, using a one-dimensional lookup table (1D-LUT) prepared for each color in advance, the multi-valued data (C, M, Y, K1, K2) is converted into multi-valued data (C′, M′, Y′, K1′, K2′).

In S507, the CPU 111 quantizes the multi-valued data (C′, M′, Y′, K1′, K2′). The output of the quantization may be a binary output or a multi-valued output with three or more levels. In a case where the result of the quantization is a multi-valued result with three or more values and the recording apparatus is to record an image in a binary fashion indicating whether to record (eject) a dot or not to record (eject) a dot, an index process or the like may be further performed on the multi-valued data after the quantization to finally convert the data into binary data. Note that, in the present embodiment, the multi-valued data (C′, M′, Y′, K1′, K2′) is converted into binary data (C″, M″, Y″, K1″, K2″).

The binary data (C″, M″, Y″, K1″, K2″) created by the series of processes described above is stored in the RAM 112 serving as a work memory.

In S508, the recording head controller 114 sequentially reads out the pieces of binary data (C″, M″, Y″, K1″, K2″) and causes the recording head 115 to perform an ejection operation using the read pieces of binary data as ejection data to thereby record an image on the recording medium.

Note that, for the lookup table referenced in the above-described color matching process, color separation process, or tone correction process, lookup tables corresponding to recording medium types and recording modes are prepared in advance; that is, multiple lookup tables are stored in the ROM 113. In response to receiving print command data, the CPU 111 analyzes the print command data, selectively reads out a lookup table corresponding to the print command from the ROM 113 and loads it to the RAM 112, and uses the loaded lookup table. Also, in the above, a case where the recording apparatus 108 executes the processes of S501 to S508 has been presented, but the present embodiment is not limited to this. The present embodiment is applicable also to a case where the PC 101 executes all or some of the processes of S501 to S507 and transmits the image data subjected to the color conversion process to the recording apparatus 108.

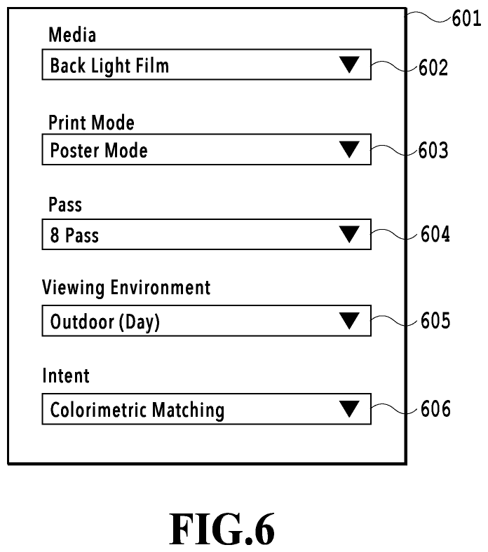

FIG. 6 illustrates a graphical user interface with which the expected viewing light source condition to be obtained in S502 is set on the PC 101. Note that a “graphical user interface” will be abbreviated as “GUI” herein. A GUI screen 601 is a setting screen for a printer driver installed in the PC 101. This screen is displayed on the display unit (not illustrated) connected via the display I/F 105. The user can selectively determine a condition on the viewing light sources via this screen.

A list box 602 is used to select the recording medium type. FIG. 6 illustrates a state where a common back light film is selected as a setting value of the recording medium type via the list box 602. Other options include a low-price back light film having fewer ink receiving layers or a thinner ink receiving layer, a high-grade back light film capable of receiving a large volume of ink, and the like, each of which is an option that enables control suitable for the recording medium's characteristics. Note that a recording medium type other than a back light film, such as plain paper, can also be selected.

A list box 603 is used to select the printing mode. Options selectable via this list box include a photograph mode (first mode) in which recording is performed at a high resolution by setting the scanning speed of the recording head low for photographs, a poster mode (second mode) in which recording is performed at a high speed and a low resolution by setting the scanning speed of the recording head high for posters, and the like. In FIG. 6, the poster mode is selected. Thus, the recording apparatus 108 is capable of operating in one mode selectively determined from among multiple modes. Note that the operation modes of the recording apparatus 108 are not limited to those listed above.

For example, the recording apparatus 108 may be equipped with multiple modes corresponding respectively to multiple viewing environments that are different from one another, and operate in one mode selectively determined from among those multiple modes. Specific examples of such modes include a first mode for outputting a printed product (output product) to be viewed in a viewing environment including both a back light and a front light, a second mode for outputting a printed product (output) to be viewed in a viewing environment including only a back light, and the like.

A list box 604 is used to select the number of recording passes. In FIG. 6, eight passes is selected.

A list box 605 is used to select the expected viewing light source condition. In FIG. 6, “Outdoor (Day)” is selected as the expected viewing light source condition. Other selectable candidates (not illustrated) include “Indoor (Daylight),” “Indoor (Neutral White),” and “Outdoor (Night)/Darkroom,” and there are four selectable types of expected viewing light source conditions in total. Here, “Daylight” and “Neutral White” are the same as the names commonly used to categorize the color temperatures of fluorescent lamps and light bulbs. Next, each of these four types of expected viewing light source conditions will be described.

“Outdoor (Day)” is considered a viewing environment in which a back light is turned in a bright outdoor setting. “Indoor (Daylight)” is considered a viewing environment in which the back light is turned on in an indoor setting with a daylight front light turned on. “Indoor (Neutral White)” is considered a viewing environment in which the back light is turned in an indoor setting with a neutral white front light turned on. “Outdoor (Night)/Darkroom” is considered a viewing environment in which no front light is present and only the back light is turned on.

A list box 606 is used to select the type of the color matching described earlier. Examples of options includes “Perceptual,” “Saturation,” and “Colorimetric Matching.” In FIG. 6, “Colorimetric Matching” is selected.

FIG. 7 is a correspondence table indicating a correspondence between a combination of expected conditions for the back light and the front light and a color matching table to be used for that combination for a setting value settable via the list box 602 and each setting value settable via the list box 605. Specifically, the table lists color matching tables (Lut-A to Lut-D) each corresponding to a combination of a setting value of the recording medium type and a setting value of the expected viewing light source condition. The color matching tables (Lut-A to Lut-D) are each created based on a combination of expected light quantities of the back light and the front light and the color temperatures of the back light and the front light. Details will be described later.

FIG. 7 will be described in detail below using a case where “Outdoor (Day)” is set via the list box 605. Note that an “expected viewing light source condition” is an expected condition for the back light source and the front light source that irradiate a printed product in a case where the printed product is viewed. In a case where “Outdoor (Day)” is selected via the list box 605, the printed product will be viewed in an environment in which the light quantity of the back light is 600 cd/m\hat{ }2, the light quantity of the front light is 600 cd/m\hat{ }2, the color temperature of the back light is 6500 K, and the color temperature of the front light 5000 K. Also, the color matching table Lut-A is determined in S503 as the color matching table to be used in the above-described color matching process (S504 in FIG. 5). The expected viewing light source condition is used to create the color matching table Lut-A. Details will be described later.

Here, the expected light quantities are each the luminance (cd/m\hat{ }2) of diffused light at the brightest portion of the viewed surface of the printed product (a portion with the lowest density, a portion with no ink). For example, the luminance from a perfect diffuse surface illuminated with 2000 lx is approximately 637 cd/m\hat{ }2, and the condition values are set with the reflection properties of the print medium itself taken into account. For example, in a case where the viewing environment setting is “Outdoor (Day),” the luminance of diffused light from the back light source is set to 600 cd/m\hat{ }2, and the luminance of diffused light from the front light source (bright outdoor light) is set to 600 cd/m\hat{ }2.

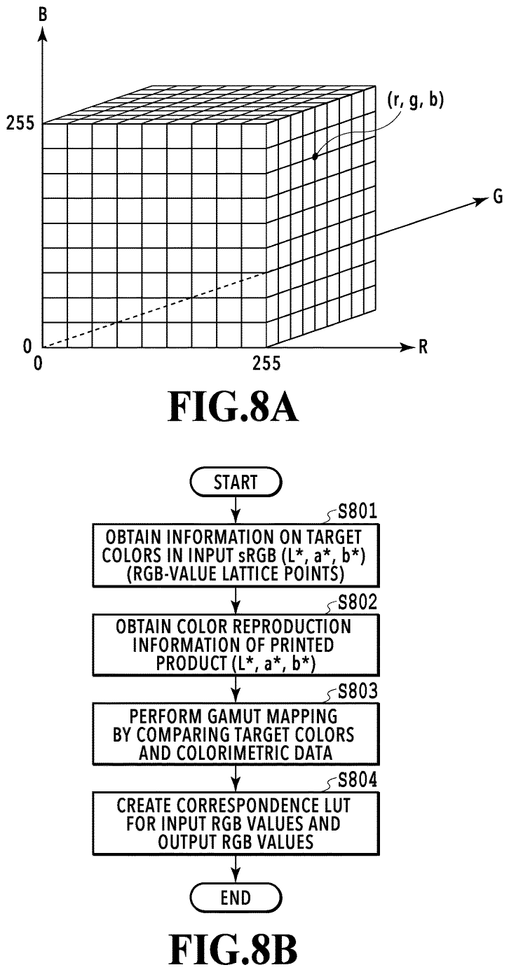

FIGS. 8A and 8B are explanatory diagrams of a method of creating a color matching table.

In the present embodiment, input image data is data represented by coordinates in the sRBG color space which are representation colors for monitors. Each color matching table is a 3D-LUT for color conversion from the device color space of an image input apparatus (input RGB) into the device color space of an output apparatus (output RGB). In the color matching process (S504), a color conversion process using a color matching table is performed. FIG. 8A is a schematic diagram of a 3D-LUT for converting RGB data being input image data into color-matched RGB data.

An input RGB color space can be represented as a cube as illustrated in FIG. 8A by being represented in a three-dimensional space with R, G, and B components along its coordinate axes. This cube is equally divided into nine parts in each of the directions of the R, G, and B axes to be divided into 729 (the cube of 9) cubes. Note that the number of divisions can be selected as appropriate, and may be, for example, 16. In the following description, a mere reference to a cube or cubes means a divided individual cube or cubes. The 3D-LUT is a table in which each of the vertices of the cubes (hereinafter referred to as “lattice points”) is associated with a pixel value in a target into which a color space is to be converted (output pixel value).

In a case where a point corresponding to an input pixel value (R, G, B) is a lattice point, an output pixel value (r, g, b) corresponding to that input pixel value can be directly obtained by referencing the 3D-LUT. On the other hand, in a case where a point corresponding to an input pixel value is not a lattice point, an output pixel value cannot be directly obtained. In this case, the output pixel value can be derived by interpolating the 3D-LUT using the output pixel values associated with the lattice points forming the cube to which the point corresponding to the input pixel value belongs. Hexahedral interpolation, triangular prism interpolation, tetrahedral interpolation, or the like can be used as the interpolation method in this case.

FIG. 8B is a flowchart illustrating a method of creating a color matching table. The following description will be given taking as an example a case of creating a color matching table corresponding to a D65 sRGB monitor. The color reproduction range of monitors and the color reproduction range of printed products are different. For this reason, it is common to use a gamut mapping technique during the creation of a color matching table. Note that the processing illustrated in FIG. 8B is executed in advance prior to the processing illustrated in FIG. 5 (e.g., at the time of shipment from the factory). Also, either the CPU 102 or the CPU 111 may execute the steps in FIG. 8B.

In S801, L*a*b* being information on sRGB for D65 as target colors (target color information) is obtained. The information obtained in this step corresponds to predetermined lattice points that form a color matching table, and is set as lattice point information in which RGB signal values are equally separated as illustrated in FIG. 8A.

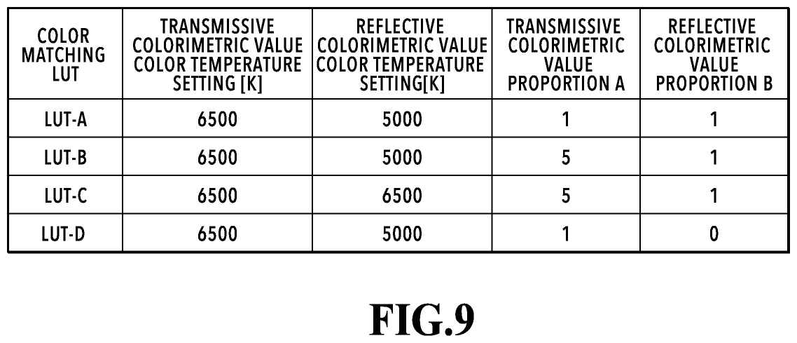

In S802, color reproduction information L*a*b* of a printed product is obtained. In the present embodiment, the printed product is assumed to be a back light film. Details of the color reproduction information of the printed product will be described later using FIG. 9, etc.

In S803, gamut mapping is performed by comparing the target colors corresponding to lattice points forming the color matching table and L*a*b* values associated with output RGB values in a color space correspondence table. Minimum color difference is a representative technique for the gamut mapping, but a different publicly known technique may be employed.

In S804, output RGB values corresponding to the minimum color difference points derived in S803 are set as colors corresponding to the lattice points forming the color matching table, i.e., lattice point data. Data storing the output RGB values corresponding to the predetermined lattice points is a color matching table created by the series of processes in FIG. 8B.

FIG. 9 is a list table for calculating the color reproduction information of the printed product in S802. Generally, patches of a combination of predetermined ink colors are recorded on a recording medium, and the result of colorimetry performed on the recorded patches under a predetermined colorimetric condition is used as the color reproduction information of the printed product. In contrast, in the present embodiment, the color reproduction information of a printed product is calculated or created. FIG. 9 illustrates conditions for calculating color reproduction information. During the creation of each color matching table (Lut-A to Lut-D), color reproduction information is calculated or created using both a transmissive colorimetric value and a reflective colorimetric value. A color temperature setting value for the transmissive colorimetric value and a color temperature setting value for the reflective colorimetric value used during the creation of the color matching table Lut-A are the same values as the respective color temperatures in FIG. 7 for “Outdoor (Day),” for which the color matching table Lut-A is selected. The ratio between a proportion A of the transmissive colorimetric value and a proportion B of the reflective colorimetric value is 1:1 (A=1, B=1), which is the ratio between the back-light light quantity of 600 cd/m\hat{ }2 and the front-light light quantity of 600 cd/m\hat{ }2 for “Outdoor (Day)” in FIG. 7.

The color temperature setting value for the transmissive colorimetric value and the color temperature setting value for the reflective colorimetric value used during the creation of the color matching table Lut-B are the same values as those used during the creation of the color matching table Lut-A. However, the ratio between a proportion A of the transmissive colorimetric value and the proportion B of the reflective colorimetric value is 5:1 (A=5, B=1), which is the ratio between the back-light light quantity of 600 cd/m\hat{ }2 and the front-light light quantity of 120 cd/m\hat{ }2 for “Indoor (Daylight)” in FIG. 7.

Using a ratio as described above to calculate or create the color reproduction information of a printed product is an important characteristic feature of the present embodiment. The equation used for this calculation is Equation 1 below. As described in Equation 1, the ratio is used to calculate a combined colorimetric value.

Combined Colorimetric Value=Transmissive Colorimetric Value T×A/(A+B)+Reflective Colorimetric Value R×B/(A+B) Equation 1

Here, the transmissive colorimetric value T is a colorimetric value measured using a back light source with an expected color temperature. The reflective colorimetric value R is a colorimetric value measured using a front light source with an expected color temperature. A is the proportion of the transmissive colorimetric value, and B is the proportion of the reflective colorimetric value.

In sum, Equation 1 combines a transmissive colorimetric value obtained by colorimetry using a transmissive light source and a reflective colorimetric value obtained by colorimetry using a reflective light source at the light quantity ratio between the expected light quantity of the back light source and the expected light quantity of the front light source. The calculation of Equation 1 is performed for each of the patches of the combination of the predetermined ink colors that are recorded on a recording medium as described above to create the color reproduction information of the printed product. Equation 1 is characterized in that the larger the expected light quantity of the back light source, the higher the ratio of contribution of the transmissive colorimetric value T to the combined colorimetric value and, conversely, the larger the expected light quantity of the front light source, the higher the ratio of contribution of the reflective colorimetric value R to the combined colorimetric value.

Also, for the colorimetry, standard light sources suitable for the color temperatures of the expected viewing light sources are used. Specifically, a D65 light source is used as a viewing light source (transmissive light source) in a case where the color temperature of the expected viewing light source is 6500 K, and a D50 light source is used as a viewing light source (reflective light source) in a case where the color temperature of the expected viewing light source is 5000 K. In the present embodiment, L*a*b* values are used as the transmissive colorimetric value and the reflective colorimetric value, but the present disclosure is not limited to this. For example, XYZ values may be used.

### <Advantageous Effects of Present Embodiment>

Advantageous effects of the present embodiment will be described below using FIG. 10. FIG. 10 is an explanatory diagram of advantageous effects of the present embodiment, and describes a viewing environment in which a back light film as a printed product is viewed as a viewing environment to which the present embodiment is applied.

In FIG. 10, the color temperature of the back light source 1001 is 6500 K. The back light source 1001 is a panel light which is an illumination panel including planarly arranged LEDs and a diffusion plate disposed thereon, and emits uniform light. The color temperature of the front light source 1003 is 5000 K. The front light source 1003 is indoor lighting represented by a fluorescent lamp or the like. In the present embodiment, the color material 1007 ejected onto the back light film 1002 is a combination of inks of five colors, as described earlier, but is illustrated in one color in FIG. 10 for brevity of description. Also, in FIG. 10, a clearance is schematically illustrated to be present between the back light source 1001 and the back light film 1002, but these are actually used in tight contact with each other.

In FIG. 10, light emitted from the back light source 1001 to the back surface of the back light film 1002 is partly absorbed and blocked by the back light film 1002 and the color material 1007, and transmitted light 1004 with a light quantity A reaches the viewer 1006. The front light source 1003 irradiates the back light film 1002 from the front side. The light is absorbed and scattered by the back light film 1002 and the color material 1007, and reflected light 1005 with a light quantity B reaches the viewer 1006.

Both the transmitted light 1004 emitted from the back light source 1001 and transmitted through the back light film 1002 and the reflected light 1005 emitted from the front light source 1003 and reflected by the front surface of the back light film 1002 are perceived by the human eye. At this time, as illustrated in FIG. 10, the color temperature of the back light source 1001 and the color temperature of the front light source 1003 may be different. As a result, the viewer 1006 views mixed light being a mixture of the transmitted light 1004 with a color temperature of 6500 K and the reflected light 1005 with a color temperature of 5000 K.

For a viewing environment in which mixed light as above is viewed, the conventional technique described earlier performs a color matching process taking only the color temperature of the back light source 1001 into account for the color matching for the back light film. This color temperature is different from the color temperature of the mixed light that reaches the viewer in a viewing environment as illustrated in FIG. 10. Hence, an appropriate color matching process cannot be performed with the conventional technique.

Specifically, attempting to perform monitor matching being a color matching process aimed at appropriately correcting the color reproduction of a monitor as in the present embodiment will result in a problem that the colors of an image displayed on the monitor and the colors of its printed product appear differently. For example, in a case where the color temperature of the back light is 6500 K and the color temperature of the front light is 5000 K, the resulting color reproduction may be warmer (more reddish) than color reproduction taking only the back light into account. Also, even in a case where the color temperature of the back light and the color temperature of the front light are equal, the color reproduction accuracy will drop if there is a difference in spectral characteristics between the transmitted light 1004 and the reflected light 1005.

In contrast, in the present embodiment, as illustrated in FIG. 9, color matching tables are each created based on both the color temperature of a back light source and the color temperature of a front light source. From among the multiple color matching tables thus created, one color matching table is selected based on user setting information given via the GUI screen 601, which is used in the color matching process in S504, and a printed product on which an image is recorded is then output. Thus, in the present embodiment, unlike the conventional technique, it is possible to perform a color matching process reflecting the effects of both the back light source and the front light source. This improves the accuracy of color matching in a viewing environment as illustrated in FIG. 10.

Also, in the present embodiment, as described in Equation 1, the transmissive colorimetric value T and the reflective colorimetric value R are combined (or blended) using the proportion A of the transmissive colorimetric value and the proportion B of the reflective colorimetric value. This improves the color reproducibility in a viewing environment as illustrated in FIG. 10.

Also, as described earlier, in the present embodiment, the configuration is such that the user can set a viewing environment via the list box 605 on the GUI screen 601, in particular, the user can select one setting value from among multiple setting values for the expected viewing light source condition. A combined colorimetric value based on a user setting given via the GUI screen 601 is calculated or generated using the ratio corresponding to a condition listed in FIG. 9. Then, one of created color matching tables is determined based on this combined colorimetric value in S503, a color matching process is performed using the determined color matching table in S504, and then printing is performed. Employing a user setting given via a GUI screen as above makes it possible to implement printing with improved color matching accuracy also in viewing environments other than that illustrated in FIG. 10.

As described above, in the present embodiment, a combined colorimetric value is used to create a color matching table. This combined colorimetric value is obtained by combining a colorimetric value with a transmissive light source (transmissive colorimetric value) and a colorimetric value with a reflective light source (reflective colorimetric value) according to the light quantity ratio between the expected light quantity of a back light source and the expected light quantity of a front light source. By employing such a configuration, it is possible to reflect both the effect of the color temperature of the back light and the effect of the color temperature of the front light in the device color reproduction range. Moreover, by employing a configuration in which the user can select a desirable combination from among multiple combinations prepared in advance in a case of setting the viewing environment condition via the GUI, it is possible to perform accurate color matching for printed products in various viewing environments.

### <Supplementary Description>

A supplementary description of the present embodiment will be given below. In the above embodiment, a method in which color matching tables are each associated with a combination of a medium name setting and a viewing environment setting, and a color matching table to be used is determined based on this combination. Alternatively, the color matching table to be used may be determined based only on the medium name setting. In that case, it is necessary to employ medium names each appropriately reflecting an expected viewing light source condition, that is, to describe medium names each representing the content of an expected viewing light source condition. While the color matching table to be used is determined based on a medium name selected by the user, this color matching table is associated with the expected light quantity and expected color temperature of a back light source and the expected light quantity and expected color temperature of a front light source. Accordingly, the effects of the expected light sources can be taken into account as in the above. An advantage of describing medium names containing the contents of expected viewing light source conditions is that an existing system, in particular, a system for adding media available to the user can be utilized without modification. Specifically, by simply changing the setting value of the medium name, a suitable color matching table can be provided without having to provide a new setting value for the viewing environment to the printer driver's GUI or a print command.

Also, each expected viewing light source condition may be associated with an intent name being an option in the list box 606, and the color matching table to be used may be determined based on an intent name selected by the user. Consider, for example, a case where there are six intent names, namely, “Perceptual,” “Perceptual (High Color Temperature),” “Saturation,” “Saturation (High Color Temperature),” “Colorimetric Matching,” and “Colorimetric Matching (High Color Temperature),” and one name is selected from among the six names via the list box 606. In this case, 5000 K as the color temperature of a back light is associated with “Perceptual,” “Saturation,” and “Colorimetric Matching.” Moreover, 6000 K as the color temperature of a back light is associated with “Perceptual (High Color Temperature),” “Saturation (High Color Temperature),” and “Colorimetric Matching (High Color Temperature).” As described above, intent names may be associated with the expected viewing light source conditions.

Each of the above-described expected viewing light source conditions, i.e., setting values of the expected color temperature and expected light quantity of a back light and the expected color temperature and expected light quantity of a front light are not limited to the ones described above. The setting values of each expected viewing light source condition may be set as appropriate based on the environment where the recording apparatus is installed.

Note that the ratio between the proportion A of the transmissive colorimetric value and the proportion B of the reflective colorimetric value in Equation 1 in the above description is the same as the ratio between the expected light quantity of the back light source and the expected light quantity of the front light source, but the setting under which the advantageous effects of the present disclosure are achievable is not limited to this. The advantageous effects of the present disclosure are achievable as long as the magnitude relationship between the proportion A of the transmissive colorimetric value and the proportion B of the reflective colorimetric value is the same as the magnitude relationship between the expected light quantity of the back light source and the expected light quantity of the front light source.

Also, the combined colorimetric value may be calculated using a combined spectrum calculated using Equation 2.

Combined Spectrum=Transmissive Spectrum T×A/(A+B)+Reflective Spectrum R×B/(A+B) Equation 2

Here, the transmission spectrum T is the spectral distribution of the back light source with the expected color temperature. The reflection spectrum R is the spectral distribution of the front light source with the expected color temperature. A is the proportion of the transmissive colorimetric value, and B is the proportion of the reflective colorimetric value.

Examples of the method of calculating the combined colorimetric value include a method of calculating colorimetric data using the combined spectrum and the spectral reflectance of a printed product obtained by colorimetry with a colorimeter. Specifically, based on the spectral distributions of the light sources and an integrated value of the spectral reflectance of the printed product, an XYZ value, or a color specification value, is calculated. An XYZ value is calculated for each of multiple color patches printed with different ink combinations. The calculated XYZ values are converted into L*a*b*. As the method of conversion (calculation) from the spectral distribution into an XYZ value and the method of conversion (calculation) from the XYZ value into L*a*b*, publicly known calculation methods are used.

In the above description, the recording apparatus has been described as an inkjet printer, but recording apparatuses to which the present embodiment is applicable are not limited to inkjet printers. The present embodiment is applicable also to recording apparatuses that perform recording by other recording methods, such as electrophotographic printing and offset printing. By employing the technique of the present embodiment, recording apparatuses capable of performing recording on a transmissive recording medium using a back light can perform accurate color matching for printed products in various viewing environments.

### Second Embodiment

In the first embodiment, the color matching table to be used is determined based on an option selected via the list box 602 and an option selected via the list box 605. Also, in the first embodiment, conditions for creating a color matching table are determined based on an expected viewing light source condition associated with a medium name being an option in the list box 602. In a second embodiment, another method will be described.

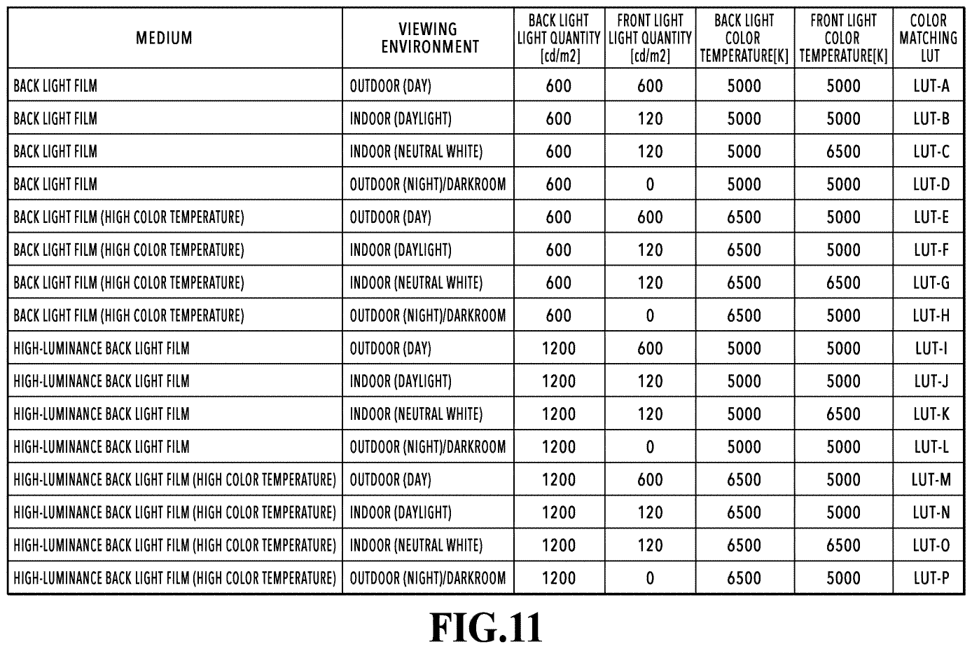

FIG. 11 is a correspondence table according to the present embodiment illustrating an example different from FIG. 7 as a correspondence between medium names settable via the list box 602, viewing environments settable via the list box 605, and color matching tables selectable in S503. As in FIG. 7, in the correspondence table in FIG. 11, each combination of setting values in the list boxes is associated with the light quantity and color temperature of a back light, the light quantity and color temperature of a front light, and a color matching table to be used with them.

Four medium types, namely, “Back Light Film,” “Back Light Film (High Color Temperature),” “High-luminance Back Light Film,” and “High-luminance Back Light Film (High Color Temperature)” are prepared. Each of these is intended to select a different back light source's expected light quantity and expected color temperature in the form of a medium name type.

In FIG. 11, the viewing environments, in particular, the expected viewing light source conditions for the back light are combinations of one of two light quantities of 600 cd/m\hat{ }2 and 1200 cd/m\hat{ }2 and one of two color temperatures of 5000 K and 6500 K. Also, the expected viewing light source conditions for the front light are combinations of one of three light quantities of 0 cd/m\hat{ }2, 120 cd/m\hat{ }2, and 600 cd/m\hat{ }2 and one of two color temperatures of 5000 K and 6500 K. As in the first embodiment, colorimetric values to be used to create a color matching table are combined according to each of the settings.

By providing more options for the expected viewing light source condition than in the first embodiment and performing a color matching process corresponding to a set condition, it is possible to implement accurate color reproduction of printed products in various viewing environments.

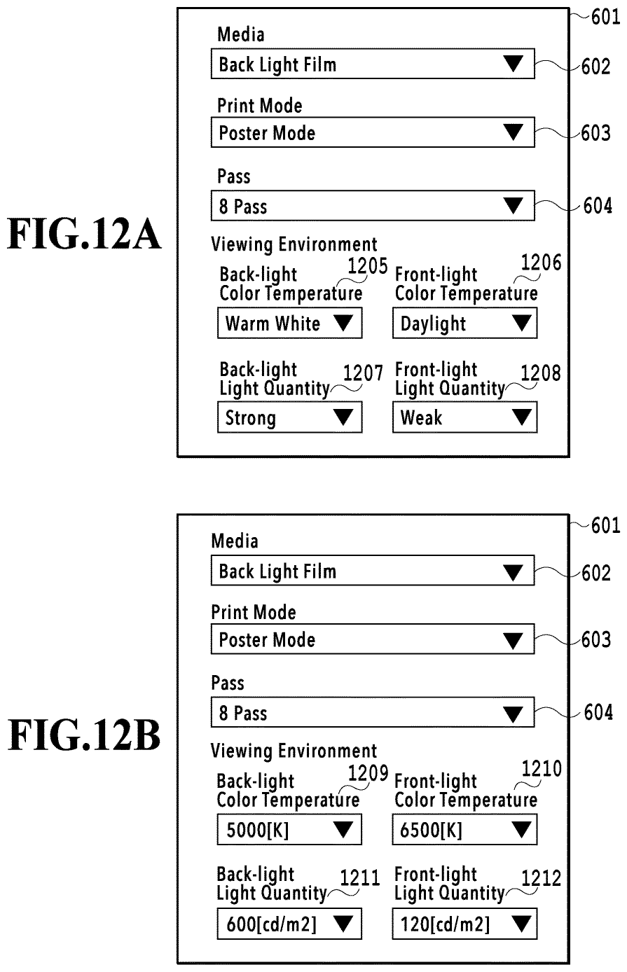

A GUI screen 601 on which settings can be configured individually for each of the back light and the front light in an expected viewing light source condition as illustrated in FIGS. 12A and 12B will be described as an example of the present embodiment. As illustrated in FIG. 12A, the GUI screen 601 in the present embodiment has list boxes 1205 to 1208, unlike the first embodiment (FIG. 6). The list box 1205 is used to select the expected color temperature of the back light. The list box 1206 is used to select the expected color temperature of the front light. There are three options for the expected color temperatures in these list boxes, namely, “Warm White,” “Daylight,” and “Neutral White.” The list box 1207 is used to select the expected light quantity of the back light. The list box 1208 is used to select the expected light quantity of the front light. There are two options, namely, “Strong” and “Weak”, for the expected light quantities in these list boxes.

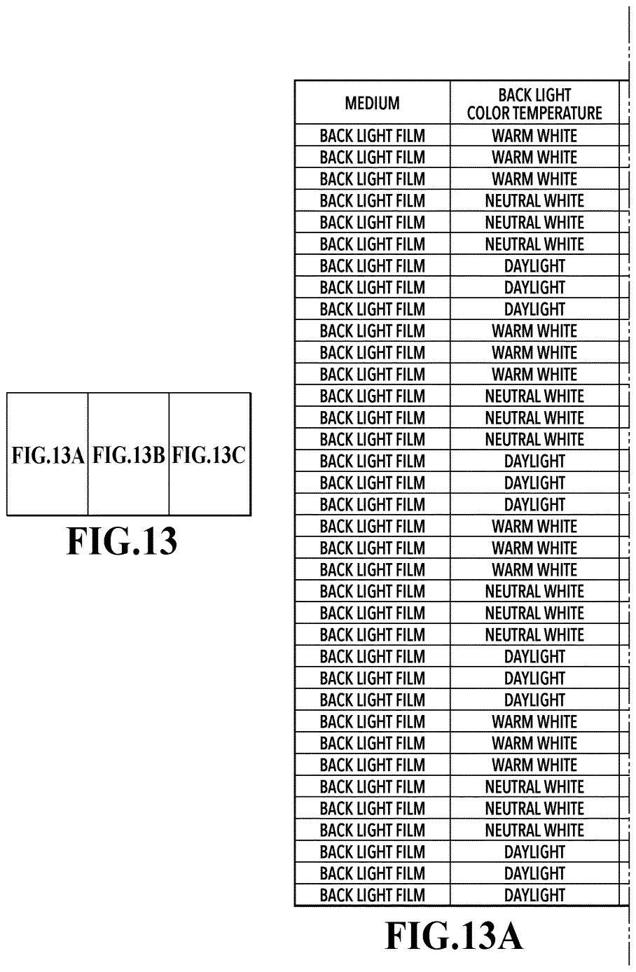

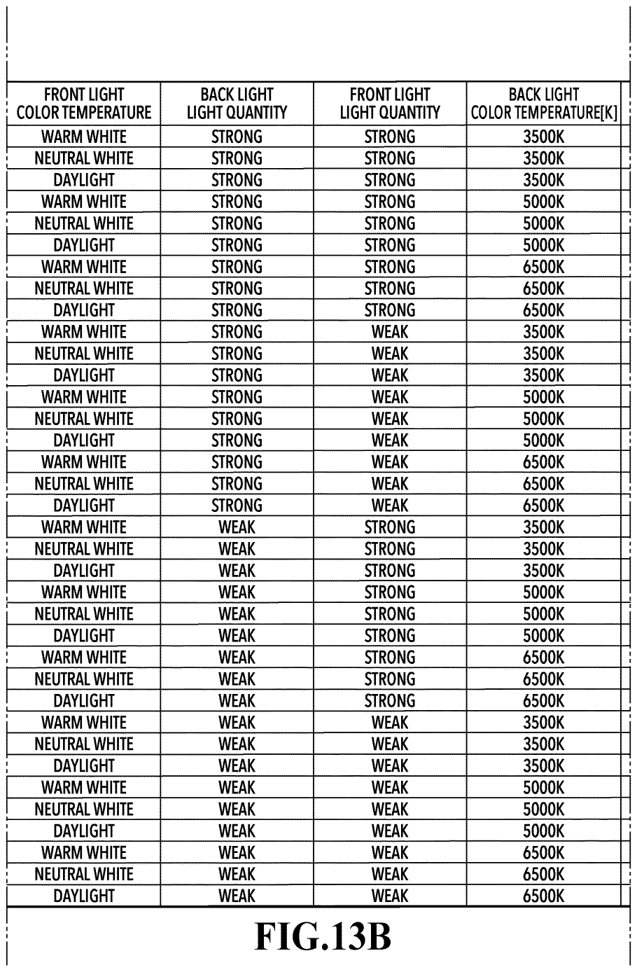

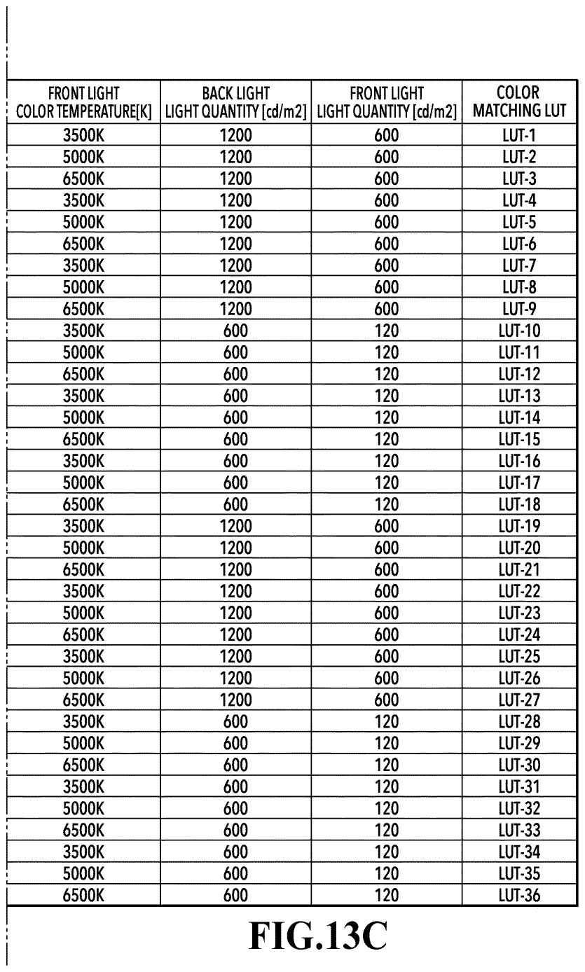

FIGS. 13A-13C indicate a color matching table determination table for the GUI screen 601 illustrated in FIG. 12A. As for the values of color temperatures corresponding to options for the expected color temperatures of the back light and the front light, “Warm White” corresponds to 3500 K, “Daylight” corresponds to 5000 K, and “Neutral White” corresponds to 6500 K. As for the values of light quantities corresponding to options for the expected light quantity of the back light, “Strong” corresponds to 1200 cd/m\hat{ }2, and “Weak” corresponds to 600 cd/m\hat{ }2. As for the values of light quantities corresponding to options for the expected light quantity of the front light, “Strong” corresponds to 600 cd/m\hat{ }2, and “Weak” corresponds to 120 cd/m\hat{ }2. Based on conditions as illustrated in FIGS. 13A-13C, multiple color matching tables are created using a color matching table creation method similar to that in the first embodiment. From among the multiple created color matching tables, one color matching table may be determined using the determination table in FIGS. 13A-13C.

Also, as one example of a colorimetric condition for obtaining the transmissive colorimetric value T and the reflective colorimetric value R to be used in Equation 1, standard light sources specified by the International Commission on Illumination (CIE) may be used. Examples of the standard light sources include an A light source, a D50 light source, a D55 light source, a D65 light source, a D75 light source, and the like, and the color temperatures of the A, D50, D55, D65, and D75 light sources are approximately 3000 K, 5000 K, 5500 K, 6500 K, and 7500 K, respectively. While the standard light sources are pseudo light sources designed to mimic natural light, they are commonly used to obtain colorimetric data, and the user can use it as substitute light source data for the expected color temperatures.

Also, as illustrated in the GUI screen 601 illustrated in FIG. 12B, numerical values may be directly input as the color temperatures and light quantities of the back light and the front light. A list box 1209 is used to input the expected color temperature of the back light. A list box 1210 is used to input the expected color temperature of the front light. In each of these list boxes, a numerical value can be input in increments of 100 K. A list box 1211 is used to input the expected light quantity of the back light. A list box 1212 is used to input the expected light quantity of the front light. In a case of using the GUI screen 601 illustrated in FIG. 12B, a color matching table corresponding to a condition may be held for each increment of the numerical value that can be input via this GUI screen 601. Also, color matching tables may be held for discrete color temperatures in increments of 500 K, for example, and any table corresponding to a numerical value between those color temperatures may be calculated by linear interpolation.

### Third Embodiment

In the first embodiment, for the colorimetric values with different color temperatures used in Equation 1, a D65 light source is set as the transmissive light source and a D50 light source is set as the reflective light source, and the colorimetric value of a printed product is generated based on their settings. In a third embodiment, a description will be given of a method of generating colorimetric values to be used for combination by a method different from the methods described above.

Specifically, it is a method in which colorimetric data is calculated using the spectral distributions of the light sources with expected color temperatures and the spectral reflectance of a printed product obtained by colorimetry with a colorimeter. Specifically, based on the spectral distributions of the light sources and an integrated value of the spectral reflectance of the printed product, an XYZ value, or a color specification value, is calculated. An XYZ value is calculated for each of multiple color patches printed with different ink combinations. The calculated XYZ values are converted into L*a*b*. As the method of conversion (calculation) from the spectral distribution into an XYZ value and the method of conversion (calculation) from the XYZ value into L*a*b*, publicly known calculation methods are used. The larger the number of color temperatures, the more time and effort will be required to measure colorimetric values. However, performing calculation using spectral reflectance as described above to calculate a colorimetric value makes it possible to easily prepare colorimetric values, and thus contributes to shortening of the process time.

Also, in the first embodiment, a color matching table is created using a combined colorimetric value derived from a transmissive colorimetric value obtained by colorimetry with a transmissive light source and a reflective colorimetric value obtained by colorimetry with a reflective light source. In the present embodiment, a desired combined color matching table is created by combining a color matching table based on a transmissive colorimetric value obtained by colorimetry with a transmissive light source and a color matching table based on a reflective colorimetric value obtained by colorimetry with a reflective light source.

First, the color matching table based on the transmissive colorimetric value is created by following the flowchart of FIG. 8B. Here, in S802, the transmissive colorimetric value is used as the colorimetric data. Besides this, the processing is the same as that in the first embodiment. The color matching table thus created will be referred to as a color matching table LUT-T for the transmissive light source.

Then, the color matching table based on the reflective colorimetric value is created by following the flowchart of FIG. 8B. Here, in S802, the reflective colorimetric value is used as the colorimetric data. Besides this, the processing is the same as that in the first embodiment. The color matching table thus created will be referred to as a color matching table LUT-R for the reflective light source.

Then, the color matching tables LUT-T and LUT-R are combined to create a combined LUT. The method of calculating the combined LUT is as described in Equation 3below.

Combined LUT=LUT-T×A/(A+B)+LUT-R×B/(A+B) Equation 3

The output RGB values of the pieces of lattice point data in the color matching tables LUT-T and LUT-R corresponding to the same input RGB are combined in accordance with Equation 3 for each of R, G, and B channels. That is, the calculation of Equation 3 is performed on the R values in the color matching tables LUT-T and LUT-R to calculate the R values in the combined LUT. Similar calculation is performed on the G values to calculate the G values in the combined LUT. Similar calculation is performed on the B values to calculate the B values in the combined LUT. Note that A is the proportion of the transmissive colorimetric value, and B is the proportion of the reflective colorimetric value, as in the first embodiment. The expected light quantities of the back light source and the front light source may be the same as those in the first embodiment. Equation 3 is characterized in that the larger the expected light quantity of the back light source, the higher the ratio of contribution of the color matching table LUT-T to the combined LUT and, conversely, the larger the expected light quantity of the front light source, the higher the ratio of contribution of the color matching table LUT-R to the combined LUT.

The combined LUT calculated in accordance with Equation 3 is an LUT in which color reproduction with the transmissive light source and color reproduction with the reflective light source are combined according to the ratio between the light sources' light quantities. By using this combined LUT as a color matching table, both the effect of the color temperature of the back light and the effect of the color temperature of the front light are reflected in color reproduction. This improves color reproducibility under an environment light on a printed product obtained by printing a back light film.

Note that, as in the first embodiment, the ratio between the proportion A of the transmissive colorimetric value and the proportion B of the reflective colorimetric value in Equation 3 is the same as the ratio between the expected light quantity of the back light source and the expected light quantity of the front light source, but the setting under which the advantageous effects of the present disclosure is not necessarily limited to this. The advantageous effects of the present disclosure are achievable as long as the magnitude relationship between the proportion A of the transmissive colorimetric value and the proportion B of the reflective colorimetric value is the same as the magnitude relationship between the expected light quantity of the back light source and the expected light quantity of the front light source.

### Other Embodiments

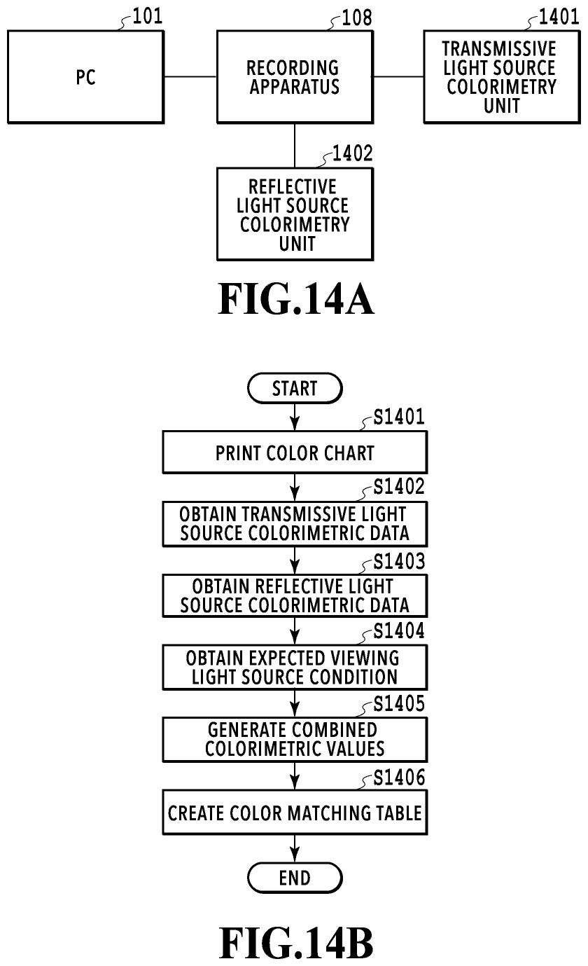

In the first embodiment, color matching tables corresponding to respective expected viewing light source conditions are held in advance, but an embodiment in which those color matching tables are not held in advance is possible. FIG. 14A is a block diagram of a hardware configuration of a printing system representing an example of such an embodiment. As illustrated FIG. 14A, the printing system further includes a transmissive light source colorimetry unit 1401 and a reflective light source colorimetry unit 1402. Based on the result of colorimetry by each of these colorimetry units, color matching tables are created for the recording medium to be actually used by the user. FIG. 14B is a flowchart illustrating a method of creating a color matching table according to such an embodiment.

In S1401, the recording apparatus 108 prints a color chart. This color chart includes multiple color patch images that are required to create a color matching table. To describe details of this step, the CPU 111 performs appropriate image processing on the above color patch images, and the recording head controller 114 causes the recording head to perform an ink ejection operation to print the color chart. Here, the appropriate image processing is preferably the image processing described in the first embodiment (FIG. 5) from which the color matching process is excluded.

In S1402, the CPU 111 obtains transmissive light source colorimetric data obtained by colorimetry by the transmissive light source colorimetry unit 1401.

In S1403, the CPU 111 obtains reflective light source colorimetric data obtained by colorimetry by the reflective light source colorimetry unit 1402. The reflective light source colorimetric data obtained in this step is desirably data obtained by performing colorimetry on a color chart printed after the elapse of a drying time that is long enough for the inks to be fixed to the recording medium.

In S1404, the CPU 111 obtains an expected viewing light source condition.

In S1405, based on the transmissive light source colorimetric data and reflective light source colorimetric data corresponding to the color temperatures in the expected viewing light source condition obtained in S1404, the CPU 111 generates a combined colorimetric value corresponding to the light quantities in the expected viewing light source condition.

In S1406, the CPU 111 creates a color matching table using the combined colorimetric values generated in S1405. Note that the processes of S1404 to S1406 may be the same as the contents described in the foregoing embodiments.

As described above, colorimetry devices may be further included as hardware components, and a color matching table may be created for a recording medium to be actually used by the user. An advantageous effect of this embodiment is that color reproduction will be more suitable for the recording medium to be used by the user than that in a case where color matching tables are held in advance.

In the foregoing embodiments, as illustrated in FIG. 10, the back surface of the back light film 1002 is irradiated only with light from the back light source 1001. Here, in a case of using a back light source for window signage or the like, there may be a distance between the back light source and the back light film. In such a case, other light than light from the back light, such as light emitted from a fluorescent lamp installed on the ceiling (hereinafter this light will be referred to as “ceiling light”), may be mixed into the light emitted to the back surface. In such a case, if the light quantity of the ceiling light is unignorably large relative to the light quantity of the back light serving as the main light (e.g., light quantity of back light:light quantity of ceiling light≈10:1), a combination process based on expected transmissive colorimetric values taking the ceiling light into account may be performed. In this way, fine color reproduction can be implemented.

As with the back light, the front light may not be one light source, and light rays from multiple light sources may be mixed and applied to the front surface of the back light film. In such a case, the reflective colorimetric values of the reflective light sources expected as the multiple light sources combined together may be combined. Conditions for light sources other than the main light sources as described above may be made settable via a GUI screen to enable more detailed settings. This makes it possible to implement fine color reproduction suitable for various environments.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to improve the accuracy of color reproduction of a back light film in an environment in which a front light is present.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. An image processing apparatus comprising:
an obtaining unit configured to obtain a viewing light source condition on viewing light sources expected to be present in a viewing environment, the viewing light source condition including a condition on a first light source expected to be a transmissive light source and a condition on a second light source different from the first light source; and
a color conversion unit configured to perform a color conversion process based on the viewing light source condition on input image data.

2. The image processing apparatus according to claim 1, further comprising a recording unit configured to perform recording on a recording medium,
wherein the recording medium includes a recording medium for a transmissive light source.

3. The image processing apparatus according to claim 2, wherein the recording unit is a recording head employing an inkjet recording method.

4. The image processing apparatus according to claim 3, wherein the image processing apparatus has a plurality of modes for a plurality of the viewing environments that are different from each other.

5. The image processing apparatus according to claim 4, wherein the plurality of modes include:
a first mode for outputting an output product to be viewed in a viewing environment including both the first light source and the second light source, and
a second mode for outputting an output product to be viewed in a viewing environment including only the first light source, and
the image processing apparatus operates in one mode selected from among the plurality of modes.

6. The image processing apparatus according to claim 1, further comprising an output unit configured to output image data subjected to the color conversion process by the color conversion unit to an inkjet recording apparatus that performs recording on a recording medium,
wherein the recording medium includes a recording medium for a transmissive light source.

7. The image processing apparatus according to claim 5, further comprising an input image data obtaining unit configured to obtain the input image data.

8. The image processing apparatus according to claim 7, wherein the second light source is a light source configured to irradiate a second surface of the recording medium for a transmissive light source with light, the second surface being on an opposite side from a first surface of the recording medium, the first surface being a surface to be irradiated by the first light source.

9. The image processing apparatus according to claim 8, wherein setting information on each of the viewing environments includes a first color temperature as a color temperature of the first light source, a second color temperature as a color temperature of the second light source, a first light quantity as a light quantity of the first light source, and a second light quantity as a light quantity of the second light source.

10. The image processing apparatus according to claim 9, further comprising a control unit configured to perform control to display a screen of a graphical user interface for changing a setting value of one of the viewing environments,
wherein the color conversion unit performs the color conversion process based on the one of the viewing environments set via the graphical user interface.

11. The image processing apparatus according to claim 10, wherein numerical values of the first color temperature, the second color temperature, the first light quantity, and the second light quantity are directly inputtable via the graphical user interface.

12. The image processing apparatus according to claim 11, further comprising a holding unit configured such that a plurality of color matching tables corresponding to an expected plurality of the viewing light source conditions are held in the holding unit in advance.

13. The image processing apparatus according to claim 12, wherein the color conversion unit executes a color conversion process based on a spectral distribution of the first light source with the first color temperature, a spectral distribution of the second light source with the second color temperature, and a ratio of the light quantity of the second light source to the light quantity of the first light source.

14. The image processing apparatus according to claim 13, wherein the color conversion unit executes a color conversion process based on a combined colorimetric value obtained by combining a first colorimetric value and a second colorimetric value using a ratio between the light quantity of the first light source and the light quantity of the second light source, the first colorimetric value being obtained by colorimetry using the first light source with the first color temperature, the second colorimetric value being obtained by colorimetry using the second light source with the second color temperature.

15. The image processing apparatus according to claim 13, wherein the color conversion unit executes a color conversion process based on a combined spectrum obtained by combining the spectral distribution of the first light source with the first color temperature and the spectral distribution of the second light source with the second color temperature using a ratio between the light quantity of the first light source and the light quantity of the second light source.

16. The image processing apparatus according to claim 13, wherein the color conversion unit executes a color conversion process based on a combined color matching table obtained by combining a first color matching table and a second color matching table based on a ratio between the light quantity of the first light source and the light quantity of the second light source, the first color matching table being based on a first colorimetric value obtained by colorimetry using the first light source with the first color temperature, the second color matching table being based on a second colorimetric value obtained by colorimetry using the second light source with the second color temperature.

17. The image processing apparatus according to claim 14, wherein the color conversion unit executes the color conversion process such that the larger the ratio of the light quantity of the second light source to the light quantity of the first light source, the higher a contribution ratio of the second colorimetric value.

18. The image processing apparatus according to claim 14, wherein the first colorimetric value is a colorimetric value obtained by colorimetry using a transmissive light source, and
the second colorimetric value is a colorimetric value obtained by colorimetry using a reflective light source.

19. The image processing apparatus according to claim 18, wherein the color conversion unit executes a color conversion process with one lookup table determined from among the plurality of color matching table.

20. The image processing apparatus according to claim 19, further comprising a creation unit connected to a transmissive light source colorimetry unit and a reflective light source colorimetry unit and configured to create the plurality of color matching tables based on transmissive light source colorimetric data obtained by the transmissive light source colorimetry unit and reflective light source colorimetric data obtained by the reflective light source colorimetry unit.

21. A method of controlling an image processing apparatus, the method comprising:
obtaining a viewing light source condition on viewing light sources expected to be present in a viewing environment, the viewing light source condition including a condition on a first light source expected to be a transmissive light source and a condition on a second light source different from the first light source; and
performing a color conversion process based on the viewing light source condition on input image data.

22. A non-transitory computer readable storage medium storing a program that causes a computer to execute a method of controlling an image processing apparatus, the method comprising:
obtaining a viewing light source condition on viewing light sources expected to be present in a viewing environment, the viewing light source condition including a condition on a first light source expected to be a transmissive light source and a condition on a second light source different from the first light source; and
performing a color conversion process based on the viewing light source condition on input image data.
